(19) United States
(12) Patent Application Publication
(10) Pub. No.: US 2026/0054600 A1
(43) Pub. Date: Feb. 26, 2026

(54) BATTERY REPLACEMENT STRUCTURE

(71) Applicant: TOYOTA JIDOSHA KABUSHIKI KAISHA, Toyota-shi (JP)

(72) Inventors: Taro MATSUSHITA, Toyokawa-shi (JP); Yukihiko IDESHIO, Nisshin-shi (JP); Shinnosuke IZUMI, Kitagunma-gun (JP)

(73) Assignee: TOYOTA JIDOSHA KABUSHIKI KAISHA, Toyota-shi (JP)

(21) Appl. No.: 19/194,626

(22) Filed: Apr. 30, 2025

(30) Foreign Application Priority Data
Aug. 22, 2024 (JP) 2024-140739

(51) Int. Cl. B60L 53/80; H01M 50/249; H01M 50/271

(52) U.S. Cl. CPC B60L 53/80; H01M 50/249; H01M 50/271; H01M 2220/20

(57) ABSTRACT

A battery replacement structure includes: a replaceable battery pack; a foldable carrier that movably supports the battery pack; and a battery housing case that includes a lid portion and that houses the battery pack and the carrier in a folded state. The battery pack includes a guide roller at an end portion on the side of being housing into the battery housing case. The battery housing case includes a support base that supports the lower surface of the battery pack, and a link mechanism that lowers the guide roller with respect to the support base in conjunction with the closing operation of the lid portion, and that raises the guide roller with respect to the support base in conjunction with the opening operation of the lid portion.

### CROSS-REFERENCE TO RELATED APPLICATION

This application claims priority to Japanese Patent Application No. 2024-140739 filed on Aug. 22, 2024. The disclosure of the above-identified application, including the specification, drawings, and claims, is incorporated by reference herein in its entirety.

### BACKGROUND

### 1. Technical Field

The present disclosure relates to a battery replacement structure.

### 2. Description of Related Art

There has hitherto been known a vehicle battery replacement device, in which a vehicle is provided with a battery tray housing space that enables insertion and removal of a battery tray, the battery tray housing space is provided with a horizontal guide device that extends horizontally from the front side toward the deeper side of the battery tray housing space and that can guide a flange formed at a side portion of the battery tray, and a retractable wheel support leg portion is provided to protrude at four corner portions of the battery tray (see Japanese Utility Model Application Publication No. 5-46527, for example). The battery tray housing space is provided with erroneous operation suppression plates in order to suppress wheels coming out during travel of the vehicle.

### SUMMARY

However, there is still room for improvement in a structure that is simple but yet can hold a battery pack so as not to be movable during travel of a vehicle and can allow the battery pack to be easily and smoothly carried out during replacement of the battery pack.

Thus, it is an object of the present disclosure to provide a battery replacement structure that is simple but yet can hold a battery pack so as not to be movable during travel of a vehicle and can allow the battery pack to be easily and smoothly carried out during replacement of the battery pack.

In order to achieve the above object, a first aspect of the present disclosure provides a battery replacement structure including: a replaceable battery pack; a foldable carrier that movably supports the battery pack; and a battery housing case that includes a lid portion and that houses the battery pack and the carrier in a folded state, in which: the battery pack includes a guide roller at an end portion on a side of being housed into the battery housing case; and the battery housing case includes a support base that supports a lower surface of the battery pack, and a link mechanism that lowers the guide roller with respect to the support base in conjunction with closing operation of the lid portion, and that raises the guide roller with respect to the support base in conjunction with opening operation of the lid portion.

According to the first aspect of the disclosure, the replaceable battery pack is movably supported by the foldable carrier, and the battery pack and the folded carrier are housed in the battery housing case including the lid portion. The guide roller is provided at an end portion of the battery pack on the side of being housed into the battery housing case. Here, the battery housing case includes the support base capable of supporting the lower surface of the battery pack, and the link mechanism that lowers the guide roller of the battery pack with respect to the support base in conjunction with the closing operation of the lid portion, and that raises the guide roller of the battery pack with respect to the support base in conjunction with the opening operation of the lid portion.

Thus, when the battery pack is housed in the battery housing case and the lid portion is closed, the guide roller of the battery pack lowers with respect to the support base, and therefore the lower surface of the battery pack is supported by the support base. That is, the battery pack is held so as not to be movable within the battery housing case. On the other hand, when the lid portion is opened in order to replace the battery pack, the guide roller of the battery pack is raised with respect to the support base, enabling the guide roller to roll on the support base and making it easier to take out the battery pack.

In this manner, according to the present disclosure, it is possible to hold the battery pack so as not to be movable during travel of the vehicle, and to carry out the battery pack easily and smoothly during replacement of the battery pack, even with a simple structure.

A second aspect of the present disclosure provides the battery replacement structure according to the first aspect, in which the battery pack includes a cover member that covers a connector provided on the battery pack; and the cover member is configured to move in conjunction with folding operation of the carrier to expose the connector.

According to the second aspect of the disclosure, the battery pack includes the cover member that covers the connector provided on the battery pack, and the cover member moves in conjunction with the folding operation of the carrier to expose the connector. That is, the connector of the battery pack is always covered by the cover member in the state of not being housed in the battery housing case. Thus, the protection performance for the connector of the battery pack is improved.

As described above, according to the present disclosure, it is possible to hold the battery pack so as not to be movable during travel of the vehicle, and to carry out the battery pack easily and smoothly during replacement of the battery pack, even with a simple structure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic side view illustrating a battery replacement structure according to a first embodiment before a battery pack is housed;

FIG. 2 is a schematic side view illustrating the battery replacement structure according to the first embodiment in the middle of housing the battery pack;

FIG. 3 is a schematic side view illustrating the battery replacement structure according to the first embodiment after the battery pack is housed;

FIG. 4 is a schematic side view illustrating, in an enlarged manner, a state of a link mechanism after the battery pack is housed in the battery replacement structure according to the first embodiment;

FIG. 5 is a schematic side view illustrating, in an enlarged manner, a state of the link mechanism when the battery pack is to be taken out of the battery replacement structure according to the first embodiment;

FIG. 6A is a schematic side view illustrating a battery replacement structure according to a second embodiment before a battery pack is housed;

FIG. 6B is a schematic side view illustrating the battery replacement structure according to the second embodiment in the middle of housing the battery pack;

FIG. 6C is a schematic side view illustrating the battery replacement structure according to the second embodiment in the middle of housing the battery pack; and FIG. 6D is a schematic side view illustrating the battery replacement structure according to the second embodiment after the battery pack is housed.

### DETAILED DESCRIPTION OF EMBODIMENTS

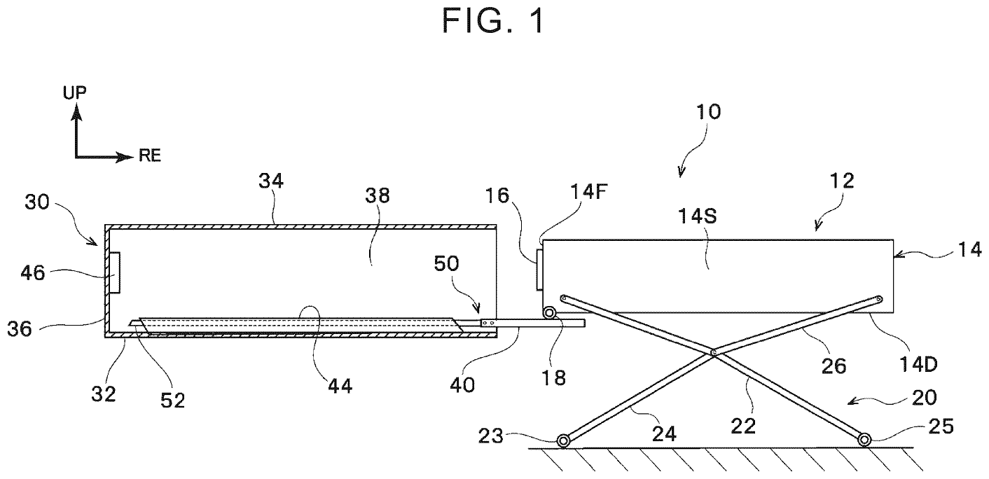

Embodiments of the present disclosure will be described in detail below with reference to the drawings. For the convenience of description, the arrow UP indicated in each drawing as appropriate indicates the upward direction of a battery pack 12 (see FIG. 1 ), and the arrow RE indicates the rearward direction of the battery pack 12, which is the direction in which the battery pack 12 is carried out of a battery housing case 30. That is, here, the forward direction is the direction in which the battery pack 12 is carried in to be housed.

Meanwhile, the direction orthogonal to the direction in which the battery pack 12 is carried into (housed in) and carried out of the battery housing case 30 in plan view is the right-left direction of the battery pack 12. Thus, when the up-down direction, the front-rear direction, and the right-left direction are indicated without special mention in the following description, the up-down direction of the battery pack 12, the front-rear direction of the battery pack 12, and the right-left direction of the battery pack 12 are indicated, respectively.

### First Embodiment

First, a first embodiment will be described. As illustrated in FIGS. 1 to 3, a battery replacement structure 10 according to the first embodiment includes a replaceable battery pack 12 to be mounted on a vehicle (not illustrated) such as a battery electric vehicle that is electrically driven, a foldable carrier 20 that is integrally attached to the battery pack 12 as a heavy object and that movably supports the battery pack 12 from the lower side, and a battery housing case 30 that can house the battery pack 12 and the folded carrier 20.

The battery pack 12 includes a battery case 14 in the shape of a substantially rectangular box having a predetermined height and with its longitudinal direction extending in the front-rear direction. A connector 16 is integrally provided at a predetermined position on a front wall 14F of the battery case 14. Further, a guide roller 18 with its axial direction extending in the right-left direction is rotatably attached to the lower part of the front end of each of the right and left side walls 14S of the battery case 14 (an end portion on the side of being housed into the battery housing case 30).

The carrier 20 includes a pair of right and left first frames 22 that extends from the upper front side toward the lower rear side in an unfolded state, a pair of right and left second frames 24, one end portion of which is pivotally coupled to substantially the center portion, in the longitudinal direction, of the first frames 22 so as to be turnable, the second frames 24 extending from substantially the center portion, in the longitudinal direction, of the first frames 22 toward the lower front side, and a pair of right and left third frames 26, one end portion of which is pivotally coupled to substantially the center portion, in the longitudinal direction, of the first frames 22 so as to be turnable, the third frames 26 extending from substantially the center portion, in the longitudinal direction, of the first frames 22 toward the upper rear side.

One end portion of each first frame 22 is pivotally coupled to the front end portion (slightly above the guide roller 18) of each of the right and left side walls 14S of the battery case 14 so as to be turnable, and a rear wheel 25 as a wheel is rotatably attached to the other end portion of each first frame 22 with its axial direction extending in the right-left direction. A front wheel 23 as a wheel is rotatably attached to the other end portion of each second frame 24 with its axial direction extending in the right-left direction. The other end portion of each third frame 26 is pivotally coupled to the rear end portion of each of the right and left side walls 14S of the battery case 14 so as to be turnable.

Thus, when the battery pack 12 is to be housed in the battery housing case 30, each second frame 24 turns rearward with one end portion as a pivot point, causing each front wheel 23 to rise, each first frame 22 turns with one end portion as a pivot point, causing each rear wheel 25 to rise, and one end portion of each third frame 26 also rises. This allows the carrier 20 to be folded.

The battery housing case 30 is provided in a vehicle, and the battery pack 12 is carried in and out from the rear side of the vehicle, for example. The battery housing case 30 includes a bottom wall 32, a top wall 34, a front wall 36, and right and left side walls 38, each of which is a substantially rectangular and flat plate that is large enough to house the battery pack 12, and is formed in a housing shape that is open on the rear side. The rear side of the battery housing case 30 is configured to be opened and closed by a lid portion 40 formed to have substantially the same size as the front wall 36.

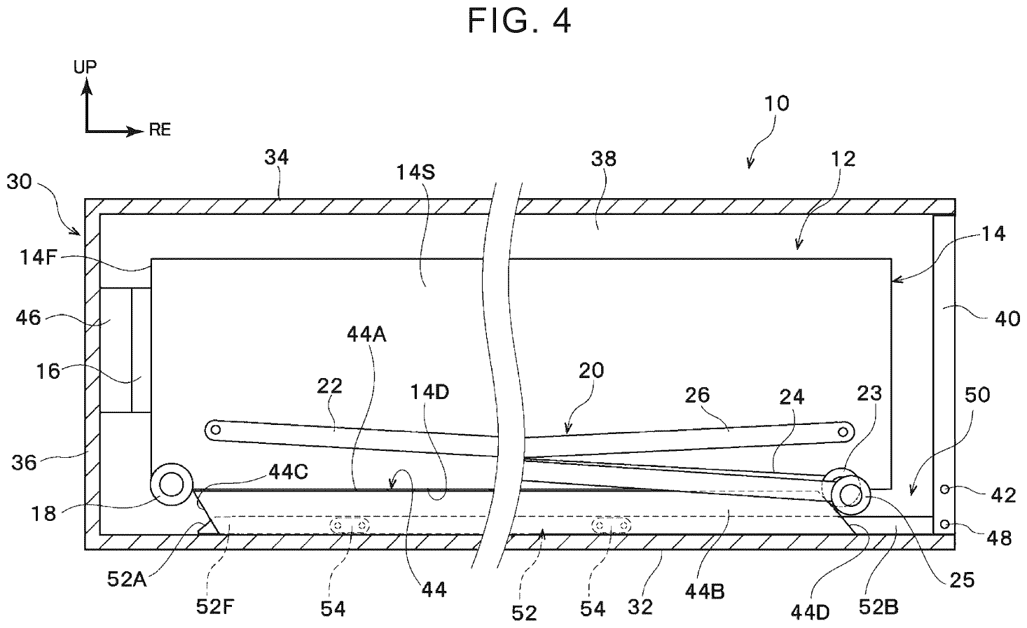

That is, when the lid portion 40 is in the closed state, the lower end portion (the lower end portion above a shaft portion 48 described later) of the lid portion 40 is pivotally coupled to the lower part of the rear end of the right and left side walls 38 so as to be turnable by a shaft portion 42 (see also FIG. 4) with its axial direction extending in the right-left direction. The front wall 36 is integrally provided with a connector 46 (see also FIG. 4) that abuts and electrically connects to the connector 16 of the battery pack 12 when the battery pack 12 is housed in the battery housing case 30.

A support base 44 capable of supporting a bottom wall 14D of the battery case 14 that constitutes the lower surface of the battery pack 12 is provided on the inner surface side of the bottom wall 32 of the battery housing case 30. The support base 44 is formed in a substantially inverted U-shape when viewed from the front in the front-rear direction. That is, the support base 44 includes a base body 44A, the upper surface of which can come into contact with the bottom wall 14D of the battery case 14, and leg portions 44B suspended downward from both the right and left end portions of the base body 44A.

The width of the support base 44 (base body 44A) in the right-left direction is substantially the same as the width of the inner surface of the bottom wall 32 of the battery housing case 30 in the right-left direction, and the length of the support base 44 (base body 44A) in the front-rear direction is shorter than the length of the inner surface of the bottom wall 32 in the front-rear direction. This enables the guide rollers 18 of the battery pack 12 and the front wheels 23 and the rear wheels 25 of the carrier 20 to be disposed on the front side and the rear side, respectively, of the support base 44 (base body 44A) when the battery pack 12 is housed in the battery housing case 30.

The leg portions 44B are formed in a substantially parallelogram shape when viewed from a side in the right-left direction. That is, the front end surface of the leg portions 44B is an inclined surface 44C that is inclined toward the upper front side, and the rear end surface of the leg portions 44B is an inclined surface 44D that is inclined toward the lower rear side. Consequently, as illustrated in FIG. 4, when the lid portion 40 is in the closed state, the upper end of the inclined surface 44C can be caused to abut against the outer peripheral surface of the guide roller 18 from the upper rear side, i.e., the guide roller 18 can be locked so as not to be movable in the front-rear direction, and the front wheels 23 and the rear wheels 25 can be supported from the lower side by the inclined surface 44D.

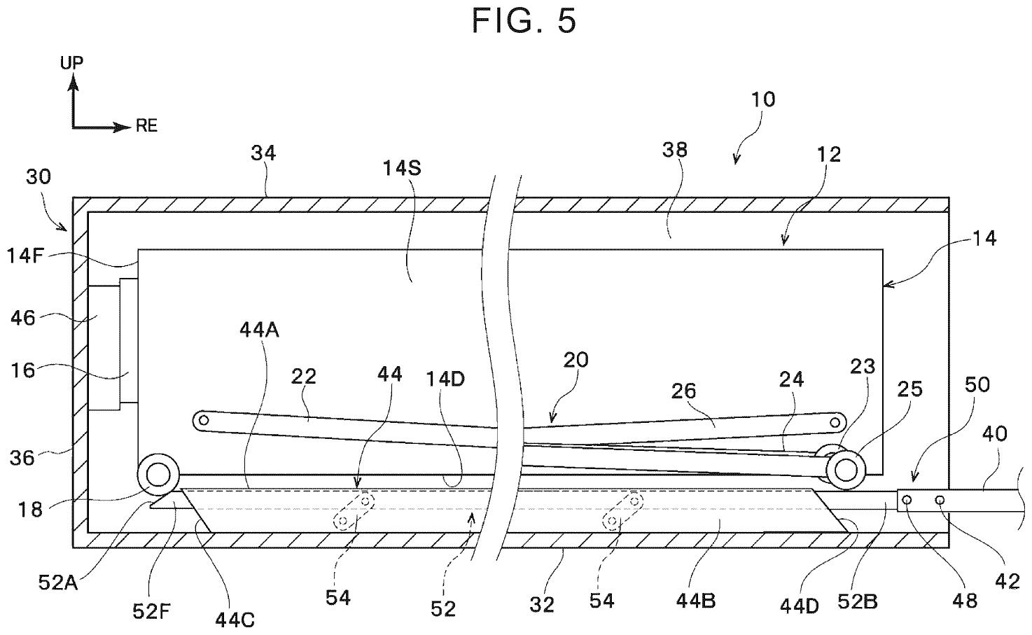

As illustrated in FIGS. 4 and 5, a link mechanism 50 is provided in a space between the base body 44A of the support base 44 and the bottom wall 32, the link mechanism 50 lowering the guide rollers 18 of the battery pack 12 and the front wheels 23 and the rear wheels 25 of the carrier 20 with respect to the base body 44A of the support base 44 in conjunction with the closing operation of the lid portion 40, and raising the guide rollers 18 of the battery pack 12 and the front wheels 23 and the rear wheels 25 of the carrier 20 with respect to the base body 44A of the support base 44 in conjunction with the opening operation of the lid portion 40.

More specifically, the link mechanism 50 includes a pair of right and left link rods 52 that extends in the front-rear direction and that is positioned below the guide rollers 18 and the front wheels 23 and the rear wheels 25 so as to overlap the guide rollers 18 and the front wheels 23 and the rear wheels 25 in plan view. When the lid portion 40 is in the closed state, the rear end portion (one end portion) of the link rod 52 is pivotally coupled to the lower end portion of the lid portion 40 below the shaft portion 42 so as to be turnable by a shaft portion 48 with its axial direction extending in the right-left direction. A plurality of link plates 54 is provided at intermediate portions, in the longitudinal direction, of the link rod 52 at predetermined intervals in the front-rear direction.

Each link plate 54 is formed in a substantially elliptical shape when viewed from a side in the right-left direction, and one end portion of the link plate 54 is pivotally coupled to an intermediate portion, in the longitudinal direction, of the link rod 52 so as to be turnable. The other end portion of each link plate 54 is pivotally coupled to the leg portion 44B of the support base 44 so as to be turnable. Each link plate 54 is configured to turn in the clockwise direction in FIG. 4 to be disposed along the longitudinal direction of the link rod 52 when the lid portion 40 is in the closed state, and to turn in the counterclockwise direction in FIG. 5 to support an intermediate portion, in the longitudinal direction, of the link rod 52 when the lid portion 40 is in the open state.

A front end portion 52F and a rear portion 52B (slightly forward of the shaft portion 48) of the link rod 52 are configured to protrude forward and rearward, respectively, from the leg portion 44B of the support base 44 by a predetermined length when viewed from a side in the right-left direction. The front end portion 52F of the link rod 52 has an inclined surface 52A that is inclined toward the lower front side when viewed from a side in the right-left direction so as to be able to support the guide roller 18 from the lower side when the lid portion 40 is in the open state.

As illustrated in FIG. 4, the link rod 52 configured in this manner is configured, when the lid portion 40 is closed, to move so as to be pulled rearward with respect to the support base 44 (to be disposed at a lower position) in conjunction with the closing movement of the lid portion 40, and therefore is supported in contact with the inner surface of the bottom wall 32 of the battery housing case 30.

On the other hand, as illustrated in FIG. 5, the link rod 52 is configured, when the lid portion 40 is opened, to move so as to be pushed toward the upper front side with respect to the support base 44 (to be held at an upper position) in conjunction with the opening operation of the lid portion 40, and therefore the guide roller 18 can be brought into contact with the inclined surface 52A of the front end portion 52F to be raised, and the front wheel 23 and the rear wheel 25 can be raised by the rear portion 52B.

Next, the function of the battery replacement structure 10 according to the first embodiment configured as described above will be described.

As described above, the battery housing case 30 includes a support base 44 capable of supporting the bottom wall 14D of the battery case 14 (the lower surface of the battery pack 12), and a link mechanism 50 that lowers the guide rollers 18 of the battery case 14 and the front wheels 23 and the rear wheels 25 of the carrier 20 with respect to the base body 44A of the support base 44 in conjunction with the closing operation of the lid portion 40, and that raises the guide rollers 18 of the battery case 14 and the front wheels 23 and the rear wheels 25 of the carrier 20 with respect to the base body 44A of the support base 44 in conjunction with the opening operation of the lid portion 40.

Thus, the battery pack 12 and the foldable carrier 20 that movably supports the battery pack 12 are carried into and out of the battery housing case 30 as follows. That is, as illustrated in FIG. 1, the battery pack 12 supported by the carrier 20 is carried (pushed) into the battery housing case 30 with the lid portion 40 open, together with the carrier 20.

Here, even if the battery pack 12 is a heavy object, a worker can easily move the battery pack 12 since the battery pack 12 is supported by the carrier 20 having the front wheels 23 and the rear wheels 25. The battery pack 12 can be replaced at a desired place without having to choose a location for replacing the battery pack 12.

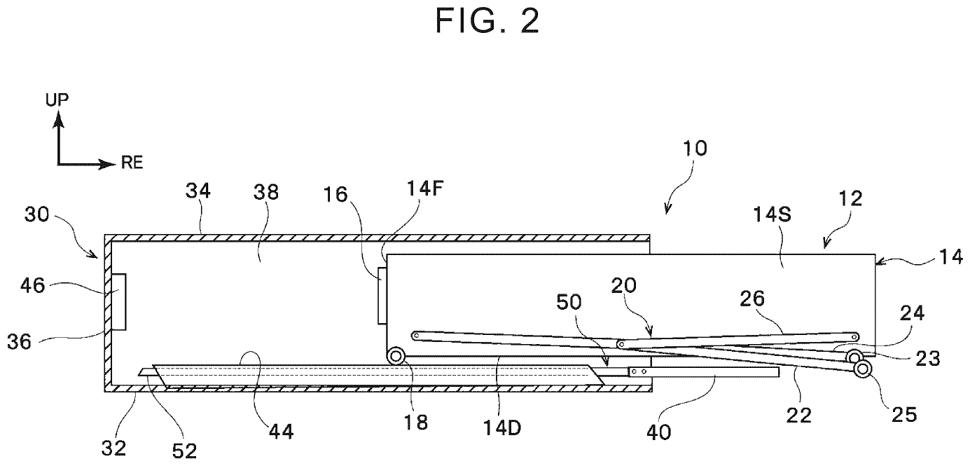

Since the lid portion 40 is in the open state, the link rod 52 of the link mechanism 50 is held at the upper position. Therefore, as illustrated in FIGS. 1 and 2, the guide roller 18 can smoothly roll from the top of the lid portion 40 in the open state to the upper surface of the base body 44A of the support base 44 through the rear portion 52B of the link rod 52. The carrier 20 is automatically folded along with operation to carry the battery pack 12 into the battery housing case 30. Thus, the battery pack 12 can be smoothly carried into the battery housing case 30 (the carry-in load can be reduced).

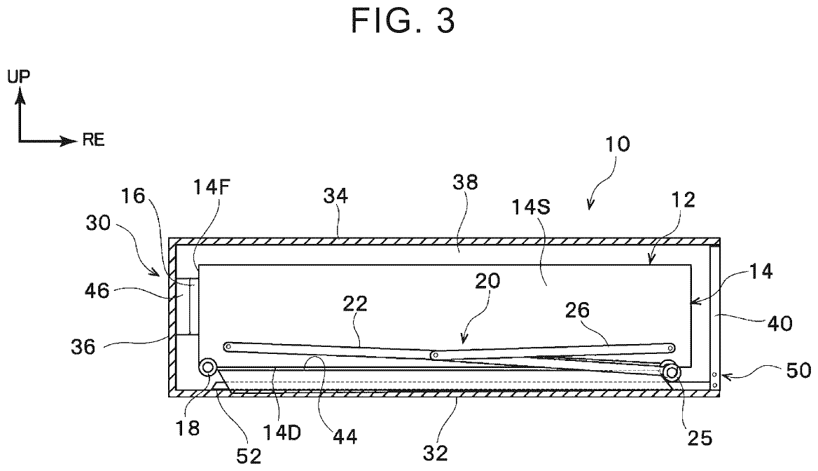

After the battery pack 12 is carried into the battery housing case 30 to a predetermined position (until the connector 16 abuts and connects to the connector 46) in this manner, the lid portion 40 is closed as illustrated in FIGS. 3 and 4, and the link rod 52 of the link mechanism 50 moves to the lower position, and therefore the guide roller 18 of the battery case 14 (battery pack 12) and the front wheel 23 and the rear wheel 25 of the carrier 20 lower with respect to the base body 44A of the support base 44.

Consequently, the bottom wall 14D of the battery case 14 (the lower surface of the battery pack 12) comes into contact with the upper surface of the base body 44A to be supported by the base body 44A. Then, the upper end of the inclined surface 44C as the front end surface of the leg portion 44B of the support base 44 abuts against the outer peripheral surface of the guide roller 18 from the upper rear side, locking the guide roller 18 so as to be immovable in the front-rear direction.

That is, the battery pack 12 is held so as not to be movable in the front-rear direction within the battery housing case 30 by causing the connector 16 to abut and connect to the connector 46 and causing the inclined surface 44C of the leg portion 44B of the support base 44 to abut against the outer peripheral surface of the guide roller 18 from the upper rear side. Thus, the battery pack 12 can be protected from vibrations that occur during travel of the vehicle.

On the other hand, when replacing the battery pack 12, that is, when taking the battery pack 12 out of the battery housing case 30, the lid portion 40 is opened as illustrated in FIG. 5. Then, the link rod 52 of the link mechanism 50 moves to the upper position (is pushed toward the upper front side), and therefore the guide roller 18 of the battery case 14 (battery pack 12) and the front wheel 23 and the rear wheel 25 of the carrier 20 rise with respect to the base body 44A of the support base 44.

This releases the lock on the guide roller 18 of the battery case 14 (battery pack 12), enabling the guide roller 18 to roll on the upper surface of the base body 44A and enabling the front wheel 23 and the rear wheel 25 of the carrier 20 to roll on the upper surface of the rear portion 52B of the link rod 52. Thus, the battery pack 12 can be easily taken out of the battery housing case 30 (easily carried out with a small force).

In this manner, according to the first embodiment, the battery pack 12 can be held so as not to be movable during travel of the vehicle, and the battery pack 12 can be easily and smoothly carried out during replacement of the battery pack 12, even with a simple structure in which the guide rollers 18 can be locked and unlocked by opening and closing operation of the lid portion 40. Thus, according to the first embodiment, the battery pack 12 can be replaced in a short time.

### Second Embodiment

Next, a second embodiment will be described. Portions equivalent to those of the first embodiment are given the same reference symbols to omit detailed description of such portions (including common functions thereof).

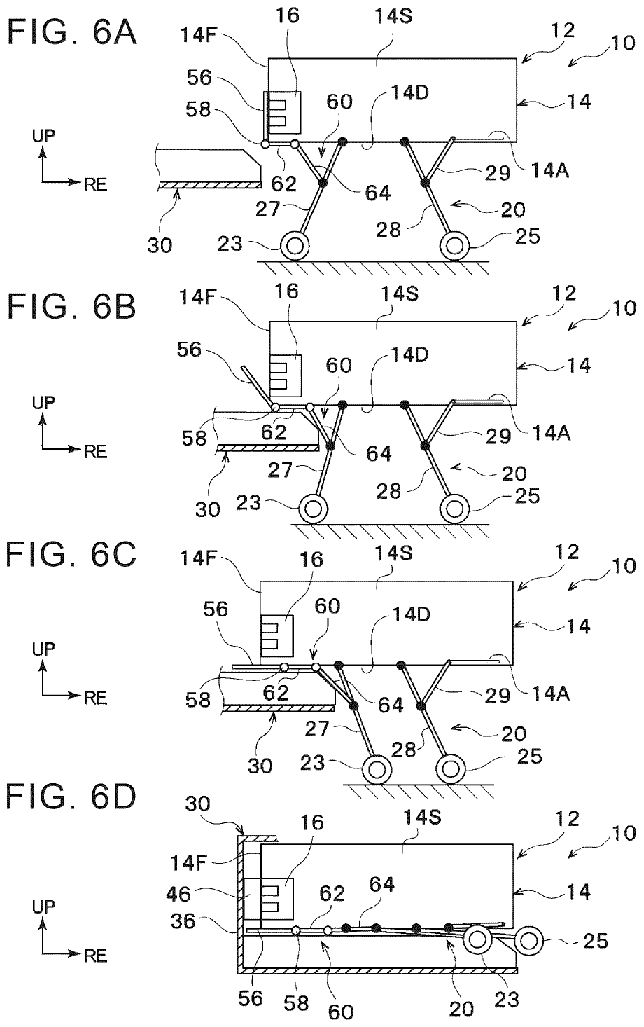

As illustrated in FIG. 6A, the second embodiment is different from the first embodiment in that the battery pack 12 includes a cover member 56 that covers the connector 16 provided on the front wall 14F of the battery case 14, and that the configuration of the carrier 20 has been changed due to the provision of the cover member 56. In FIGS. 6A, 6B, 6C, and 6D, the guide roller 18 is not illustrated.

In the second embodiment, the carrier 20 includes a pair of right and left first frames 27 that extends toward the lower front side in an unfolded state, a pair of right and left second frames 28 that extends toward the lower rear side, and a pair of right and left third frames 29, one end portion of which is pivotally coupled to substantially the center portion, in the longitudinal direction, of the second frames 28 so as to be turnable, the third frames 29 extending from substantially the center portion, in the longitudinal direction, of the second frames 28 toward the upper rear side.

One end portion of each first frame 27 is pivotally coupled to the lower end portion of each of the right and left side walls 14S of the battery case 14 forward of the center portion in the front-rear direction, and a front wheel 23 as a wheel is rotatably attached to the other end portion of each first frame 27 with its axial direction extending in the right-left direction.

One end portion of each second frame 28 is pivotally coupled to the lower end portion of each of the right and left side walls 14S of the battery case 14 rearward of the center portion in the front-rear direction, and a rear wheel 25 as a wheel is rotatably attached to the other end portion of each second frame 28 with its axial direction extending in the right-left direction.

The other end portion of each third frame 29 is coupled to a portion of each of the right and left side walls 14S of the battery case 14 rearward of one end portion of each second frame 28 so as to be slidable further rearward from the portion. That is, groove portions 14A that slidably support the other end portion of each third frame 29 are formed in the lower rear portion of each of the right and left side walls 14S of the battery case 14.

Thus, as illustrated in FIGS. 6B to 6D, when the battery pack 12 is to be housed in the battery housing case 30, each first frame 27 turns rearward with one end portion as a pivot point, causing each front wheel 23 to rise, and each second frame 28 turns rearward with one end portion as a pivot point, causing each rear wheel 25 to rise. Then, the other end portion of each third frame slides rearward. This allows the carrier 20 to be folded.

Furthermore, the cover member 56 is configured to move rearward in conjunction with the folding operation of the carrier 20 to expose the connector 16. More specifically, a turning shaft 58 with its axial direction extending in the right-left direction is provided at the lower end portion of the cover member 56, and the cover member 56 is constantly biased in the direction of covering the connector 16 (in the clockwise direction in FIGS. 6A, 6B, 6C, and 6D) by a biasing member (not illustrated) such as a torsion spring provided on the turning shaft 58.

The turning shaft 58 is provided with a slide mechanism 60 that slides the cover member 56. The slide mechanism 60 includes a first slide rod 62, the front end portion (one end portion) of which is pivotally coupled to both axial end portions of the turning shaft 58 so as to be turnable, and the first slide rod 62 is supported on the battery case 14 so as to be slidable in the front-rear direction.

The upper end portion (one end portion) of a second slide rod 64 is pivotally coupled to the rear end portion (other end portion) of the first slide rod 62 so as to be turnable, and the lower end portion (other end portion) of the second slide rod 64 is pivotally coupled to substantially the center portion, in the longitudinal direction, of the first frame 27 so as to be turnable. Thus, when the first frame 27 is turned rearward, the second slide rod 64 is pulled rearward, and the first slide rod 62 slides rearward.

Consequently, the turning shaft 58 is pulled rearward, and therefore, as illustrated in FIGS. 6B to 6D, the cover member 56 is turned forward (in the counterclockwise direction in FIGS. 6A, 6B, 6C, and 6D) about the turning shaft 58, opening the connector 16. When the connector 16 is opened in this manner, the connector 16 abuts and electrically connects to the connector 46 provided on the front wall 36 as the battery pack 12 is carried into the battery housing case 30 to a predetermined position.

When the battery pack 12 is carried out of the battery housing case 30, the first frame 27 turns forward, thereby pushing out the second slide rod 64 forward and sliding the first slide rod 62 forward. When the turning shaft 58 passes beyond the lower part of the front end of the battery case 14, the cover member 56 is turned rearward (in the clockwise direction in FIGS. 6A, 6B, 6C, and 6D) by the biasing force of the biasing member to cover the connector 16.

In this manner, according to the second embodiment, the cover member 56 is configured to move in conjunction with the folding operation of the carrier 20 to expose the connector 16, and thus the connector 16 of the battery pack 12 is configured to be always covered by the cover member 56 when the battery pack 12 is not housed in the battery housing case 30. Thus, the protection performance for the connector 16 of the battery pack 12 can be improved.

While the battery replacement structure 10 according to the present embodiment has been described above based on the drawings, the battery replacement structure 10 according to the present embodiment is not limited to the one illustrated in the drawings, and design changes can be made as appropriate without departing from the gist of the present disclosure. For example, the battery pack 12 may be configured to be carried in and out from the right side or the left side of the vehicle. The link rod 52 of the link mechanism 50 is not limited to being configured to be supported by the link plates 54.

The link mechanism 50 may raise and lower only the guide rollers 18. That is, the link mechanism 50 may be configured to lower at least the guide rollers 18, among the guide rollers 18 and the front wheels 23 and the rear wheels 25, with respect to the support base 44 in conjunction with the closing operation of the lid portion 40, and to raise at least the guide rollers 18, among the guide rollers 18 and the front wheels 23 and the rear wheels 25, with respect to the support base 44 in conjunction with the opening operation of the lid portion 40.

What is claimed is:

1. A battery replacement structure comprising:
a replaceable battery pack;
a foldable carrier that movably supports the battery pack; and
a battery housing case that includes a lid portion and that houses the battery pack and the carrier in a folded state, wherein:
the battery pack includes a guide roller at an end portion on a side of being housed into the battery housing case; and
the battery housing case includes
a support base that supports a lower surface of the battery pack, and
a link mechanism that lowers the guide roller with respect to the support base in conjunction with closing operation of the lid portion, and that raises the guide roller with respect to the support base in conjunction with opening operation of the lid portion.

2. The battery replacement structure according to claim 1, wherein:
the battery pack includes a cover member that covers a connector provided on the battery pack; and
the cover member is configured to move in conjunction with folding operation of the carrier to expose the connector.
